(19) United States
(12) Patent Application Publication
(10) Pub. No.: US 2025/0229229 A1
(43) Pub. Date: Jul. 17, 2025

(54) Automated Filtration System Incorporating Machine Vision For Control and Monitoring

(71) Applicant: Yingqing Huang, Buffalo Grove, IL (US)

(72) Inventor: Yingqing Huang, Buffalo Grove, IL (US)

(21) Appl. No.: 18/412,557

(22) Filed: Jan. 14, 2024

(51) Int. Cl. B01D 61/22; B01D 61/18

(52) U.S. Cl. CPC B01D 61/22; B01D 61/18; B01D 2313/18; B01D 2313/243; B01D 2313/701; B01D 2313/903; B01D 2315/10

(57) ABSTRACT

In some aspects thereof, the present invention discloses automated filtration systems integrating machine vision for monitoring and control. The system apparatus employs cameras to capture continuous images of interconnected fluid containers, tubes, and filtration devices, these visuals are processed through neural network models tailored for mapping critical parameters such as fluid liquid level, volume, turbidity, color, and leak detection. This multidimensional perception enables real-time control and regulation of the system components, such as pumps and valves, establishing a closed-loop system for the precise control of pressures, flow rates, and liquid transfers essential for efficient operational cycles. Configurable analytics, automated diagnostics, and data offloading enhance process ruggedization, minimizing manual intervention.

### FIELD OF INVENTION

The present invention relates generally to systems and methods for tangential flow and direct flow filtration systems and associated control methods for automation, incorporating machine vision technology for precise monitoring and management of process parameters such as flow rates, fluid levels, pressure, and flow resistance. The invention further pertains to repeatable and efficient automated sample concentration, purification, and processing for small sample volumes down to a few milliliters or less, applicable towards applications in biotechnology, life sciences, and analytics.

### BACKGROUND OF THE INVENTION

Tangential flow filtration (TFF) is a well-established technique for separation and purification, relying on the tangential flow of fluid across a membrane to reduce fouling. It is widely applied in ultrafiltration and microfiltration across biotechnology and life sciences.

While automated TFF systems enable convenient filtration, concentration and buffer exchange, current setups require additional supporting equipment like pumps, scales, and control systems. This significantly increases complexity and cost, limiting suitability for small-scale contexts processing minimal sample volumes. For tiny volumes of a few milliliters, perturbation from human operation, system vibration, tube stress can also impede accurate weight measurements.

There is growing demand for automated small-volume TFF processing for emerging applications in cell/gene therapy, medical diagnostics, and exosome processing, and others. However, these are often still reliant on manual monitoring and intervention when the liquid level approaches the bottom or the top of liquid containers, proving inefficient and irreproducible. Direct in-line sensing can disturb the closed disposable flow path, while compact non-contact options remain lacking.

Additionally, the non-linear interplay between pinch valve closure and back pressure for fine tubing hampers precise resistance control, due to increased sensitivity to valve closure when tubing ID gets smaller. Though vital in larger systems, monitoring liquid levels with conventional contacting sensors or scales demands calibrations and maintenance, constraining flexibility.

It is apparent that current TFF automation solutions pose cost, accuracy, and flexibility barriers in small-volume tangential flow filtration contexts below a few milliliters. Reliable non-contact approaches for process measurements are lacking, compelling manual oversight for attaining acceptable repeatability, productivity, and safety.

Recent advances in machine vision and AI offer powerful capabilities to overcome these limitations through intelligent multivariate process management. As such, the proposed invention outlines automated filtration system optimized for small fluid volumes, integrating machine vision for enhanced process control and monitoring. Rather than ancillary instrumentation like scales, it employs non-contact approaches for direct measurements with reduced system cost and potential expanded automation.

Specifically, the integration of cameras and AI-based image processing facilitates non-invasive tracking of fluid levels and interface positions over the course of filtration processes. This data enables precise real-time regulation of process parameters like turbidity, colors, and pH with the assistance of pH indicators, to optimize productivity, safety and reproducibility.

Additionally, the vision system grants further insights into filtration process status such as bubble formation for proactive mitigation. By correlating multivariate visual, pressure, flow rate or filtration fluxes, predictive analytics models can be developed to spotlight anomalies and automatize corrective interventions.

Without specially mention, the system can be used in advanced direct flow process control to provide liquid level monitoring capability for process control and process safety alarming.

As such, the proposed solution aims to deliver a compact and cost-effective automated filtration system most suitable for small final sample volumes under 100 mL or much less. Beyond automation, the incorporation of machine vision technology ensures accurate non-contact measurements for liquid levels and flows suiting other processing systems. This allows simplified workflows and foolproof sample processing unattended.

It is therefore, an objective of the current invention to coalesce filtration know-how with data-driven AI models trained over diverse operating conditions. Such a multi-parameter vision sensing scheme would surpass limitations of conventional liquid sensors demanding setup tweaks and large process volumes. Thus, the invention strives to make automated precision filtration more accessible to life science laboratories.

### SUMMARY OF THE INVENTION

The following summary is an explanation of some of the general inventive steps for the system, method, devices, and apparatus in the description. This summary is not an extensive overview of the invention and does not intend to limit its scope beyond what is described and claimed as a summary.

In some embodiments thereof, the present invention discloses automated filtration systems integrated with machine vision for precision process monitoring and control. A modular imaging module, comprising high-resolution cameras and illumining sources, continuously feeds real-time visual data of the filtration unit into an integrated image processing unit. A data-driven model based on convolutional neural networks is built and trained on labeled images and videos representing variations in containers, liquid levels, process components, and anomalies. The image processing unit runs the trained model to accurately infer the current liquid levels and process integrity, transmitting this multivariate data to predictive analytics algorithms. The analytics then direct corrective action by the feedback control unit linked to pumps, valves, and other actuators by a closed-loop regulation of pumps and valves to achieve target concentration factors. Over time, the deployed vision model is iteratively enhanced through continuous data accrual monitoring failure cases, improving detection robustness across diverse operating configurations. This tight perception-action loop thus furnishes reliable closed-loop automation for high-precision, small-volume tangential flow filtration applications.

In another aspect of the disclosure, the machine vision system is trained on collected images representing operation for a range of process volumes, sample color, sample turbidity, flow path configurations etc. The visual data then undergoes cleaning and labeling marking regions of interest like interfaces, bubbles or leaks. This dataset serves to train a convolutional neural network, tuning architectural hyperparameters, liquid levels, and weights to accurately map input images to labeled components and properties. The trained model is quantified on a distinct test set measuring detection precision over new data examples. Additional data accrued monitoring real-world deployments allows further refinement via techniques like transfer learning. Thereby, the system continuously integrates new edge cases most apt to confound earlier model versions. This endows it the capacity to handle unconstrained photometric variances, occlusion, and background clutter-hallmarks of industrial environments. Thereby, the integrated vision technique offers adaptive automation and enhanced process ruggedization.

In some aspects, the system features integrated components custom-tailored to liquid level detection and process oversight in filtration processes. One embodiment outlines optics and algorithms for discerning fluid levels against graduation marks on containers, transmitting this to an inlet flow regulation unit such as a pump. Another variation employs colored or shape-coded labels applied to the exterior surface of vessels and tubing to signify thresholds like minimum, maximum, alarming or pump shut-down liquid heights during concentration cycles. Still another embodiment applies a pH indicator into the sample, allowing the system to infer pH of sample. A more advanced embodiment applies volume approximation through a neural topology assessing detected fill height against container dimensions. The system also monitors for anomalies like leaks or tube bursts, securing visual data spanning the failure and triggering automated safety interventions per pre-configured protocols. Across embodiments, the continuous capture and analysis of images enables the refinement of process control logic and diagnostics performance via incremental training over expanded curated datasets.

In a non-limiting aspect, the machine vision technology monitors process health and anomalies. By assessing tube contours, it rapidly detects leaks, ruptures, or blockages, securing visual records while triggering safety interventions like system shutdown. The image feed also discerns filtrate color and turbidity, signaling potential membrane and flow path compromise. Accrued big visual data helps deepen diagnostics, with the model progressively learning transient, edge-case or obscured patterns that may escape human operators.

In a further aspect, the disclosed system incorporates a recirculation pump establishing tangential flow across a membrane filter. Tubing, filters, and other flow path components collectively form a closed sample-retentate loop, with permeate collection in an independent container. Additional reservoirs connected via optional pumps and tubing allow buffer introduction or supplemental feed. The vision module monitors each liquid level, transmitting this to a controller directing pump actuation. Level sensors could provide redundant validation, with additional pressure transducers enabling alternate process control schemes like constant backpressure operation.

In various aspects, the proposed invention outlines smart filtration systems based on non-invasive machine vision. The systems intend to make precise, automated sample processing accessible for emerging TFF applications down to single digit milliliter quantities or even less, and/or enable automated direct filtration flow automation with reduced hardware costs and improved safety profiles.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 shows a schematic diagram outlining the exemplary components of the integrated machine vision system for process monitoring and control, including imaging devices, vision processing units, control systems and feedback loop.

FIG. 2 illustrates the machine learning pipeline for developing robust vision algorithms, encompassing training data collection and annotation, neural network model design, evaluation on validation image sets and continuous retraining on newly accrued images.

FIG. 3 exhibits sample embodiments of exterior container markings and labels to demarcate target fluid heights for enabling precise, non-contact level detection using the machine vision approach.

FIG. 4 presents an implementation variant where the automated machine vision technique is applied for closed-loop monitoring and control of a tangential flow filtration system.

FIG. 5A depicts alternate deployments of the invention for automated oversight and regulation of a direct flow, single-pass filtration system.

FIG. 5B depicts alternate deployments of the invention for automated oversight and regulation of a direct flow, single-pass filtration system using only filtration pump.

FIG. 6 portraits a magnification of a mechanical actuator design for pinch valves with moving parts that forms multiple tubing slots for pressure and flow regulation of a smart filtration assemblies outlined herein.

### DETAILED DESCRIPTION OF THE PREFERRED EMBODIMENTS

Hereinafter, the preferred embodiment of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

In this disclosure, the term exemplary may be construed as to mean embodiments that are provided as examples.

In some aspects, this invention introduces an automated filtration system employing integrated machine vision for precision process monitoring and control. Machine vision allows cost-effective, non-invasive sensing tailored for liquid level tracking and container volume approximation. The streamlined design applies to both tangential crossflow and direct single-pass filtration workflows.

The system features at least one feed pump and calibrated imaging components customized for volume approximation of process liquid reservoirs. This is coupled with an intelligent visual recognition scheme for real-time fluid height and air-liquid boundary tracking. Additional provisions exist for incorporating replenishment pumps and valve actuators interfaced to a central controller.

In a tangential flow configuration, the circulation loop comprises a sample container, coupled to a TFF filter through feed and return tubing. Permeate collection directing through an independent outlet completes the flow path. The machine vision methodology allows close tracking and regulation of retentate volume within the recirculation, enabling target concentration factors, maintaining liquid height of the retentate. Integrated analytics further allows identification of anomalies and preventative intervention.

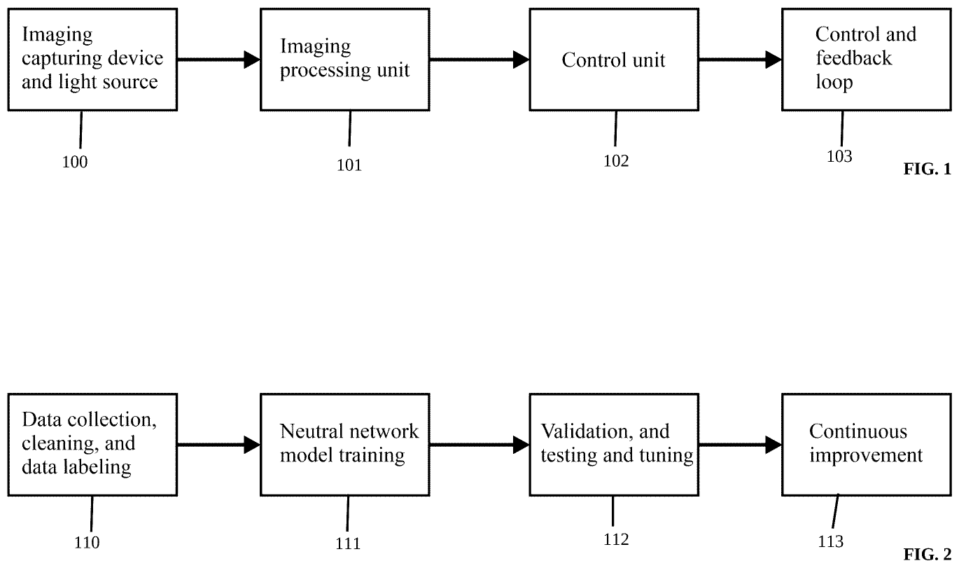

In the illustrated embodiment of FIG. 1, a representative embodiment of the invention integrating machine vision for automated filtration control is depicted. The schematic diagram outlines an image capturing device and light source module (100), which may be strategically positioned to secure well-illuminated, high-resolution image or video feed of the process containers and flow circuitry or so called flow path. This may comprise an ensemble of multiple optical sensors and illumination sources arranged at various vantage points for comprehensive visual coverage.

Further, the captured images stream into the image processing unit (101), which may be adapted to execute specialized neural network models trained to perform analysis tasks like fluid level sensing, leak detection, and color or turbidity tracking. The processor may extract key parameters like liquid volumes, turbidity, and process integrity to transmit to the control unit (102). This central regulation module houses predictive algorithms that actuate pumps, valves and other components based on current process state and prescribed volume levels or pressures.

Further shown is control and feedback loop (103), which may create a closed-loop architecture for adaptive process management. Here the machine vision data and control unit responses create a temporally evolving multivariate dataset logged into the image processor.

Statistical analytics help refine the vision model while discovering optimal control logic. Additional embodiments also allow operator overrides through this user interface loop. Thereby the system incrementally learns the intricacies of the fluidic process, building an increasingly accurate digital twin to automate routine operations. The integrated artificial intelligence approach thereby furnishes precise, consistent and safe next-generation filtration technology.

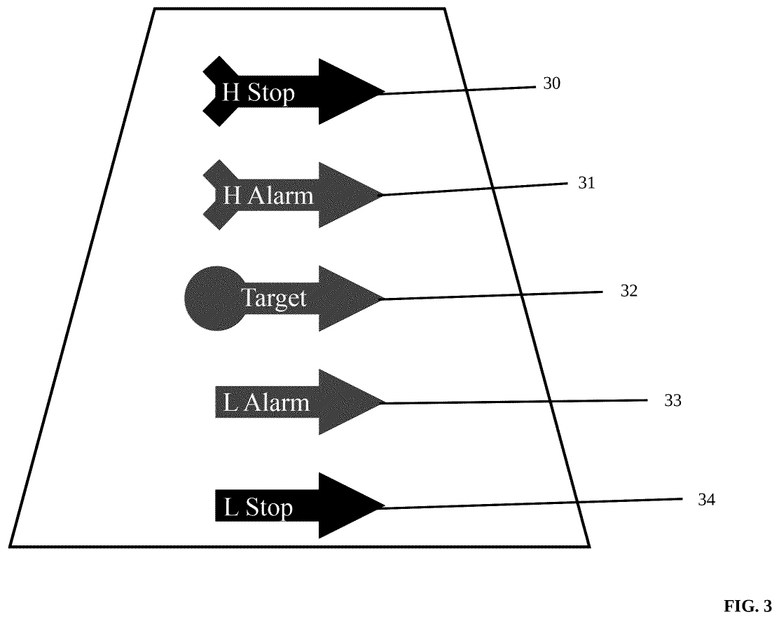

The exemplary embodiment according FIG. 2 illustrates an exemplary end-to-end machine learning workflow for constructing a tailored computer vision system to automate filtration monitoring and control. This adaptive data-driven approach allows the assembly to handle unpredictable variations in containers, illumination, or background clutter pervasive across industrial settings.

The process initiates with curating a corpus of images depicting the filtration hardware under diverse configurations through the data collection, cleaning and labeling step (110). Careful effort ensures accrual of scenarios spanning expected ranges of volumes, concentrations, tube dimensions and component types. The visual data then undergoes cleaning, rectifying corrupted samples and removing redundancies. Domain experts provide meticulous manual annotations, marking fluid interfaces, bubbles, leaks, and other regions critical for oversight. Additional augmentation generates modified versions to improve model robustness.

A functional aspect of the disclosure relies on neural network model training (111), leveraging architectures like convolutional neural networks to ingest this vast labeled dataset.

Through iterative optimization of network weights over annotated examples, the system discerns complex visual patterns, learning to accurately locate and classify key components necessary for process regulation. Misprediction rates over training data are used to guide refinements, ensuring resilience against overfitting.

The subsequent validation, testing and tuning phase (112) quantifies generalization capacity over fresh unlabeled footage captured in independent trials. Performance metrics based on precision and recall are used to select models resilient against dataset biases. Supplementary data augmentation and regularization techniques further enhance ruggedness against video variations manifested in real-world deployments.

The continuous improvement module (113) enables the model's adaptation through periodic retraining as new images accrue in production lines. Focus on hard negative examples, where current models falter, rapidly integrates emerging corner cases into software updates. Thereby, the system persists robust despite changes in procedure, equipment, or personnel. Tight version tracking maintains operational transparency.

Once trained, the vision system divides images into salient regions to detect and track key fluid containers non-invasively. The custom neural network model, trained on diverse image datasets as elaborated previously, identifies sample vessels, waste reservoirs, buffer tanks and other containers by learning distinct visual signatures like shapes, textures, and markings.

In a simple illustrative embodiment, the algorithm processes images to pinpoint graduation marks or numeric volume labels on process containers, sensing liquid levels relative to these exterior indicators. By mapping pixel positions to real-world coordinates through camera calibration, the vision technique computes absolute fluid quantities. Users can configure allowable ranges and threshold breaches that automatically log alerts or actuate top-up pumps using interfaced control systems.

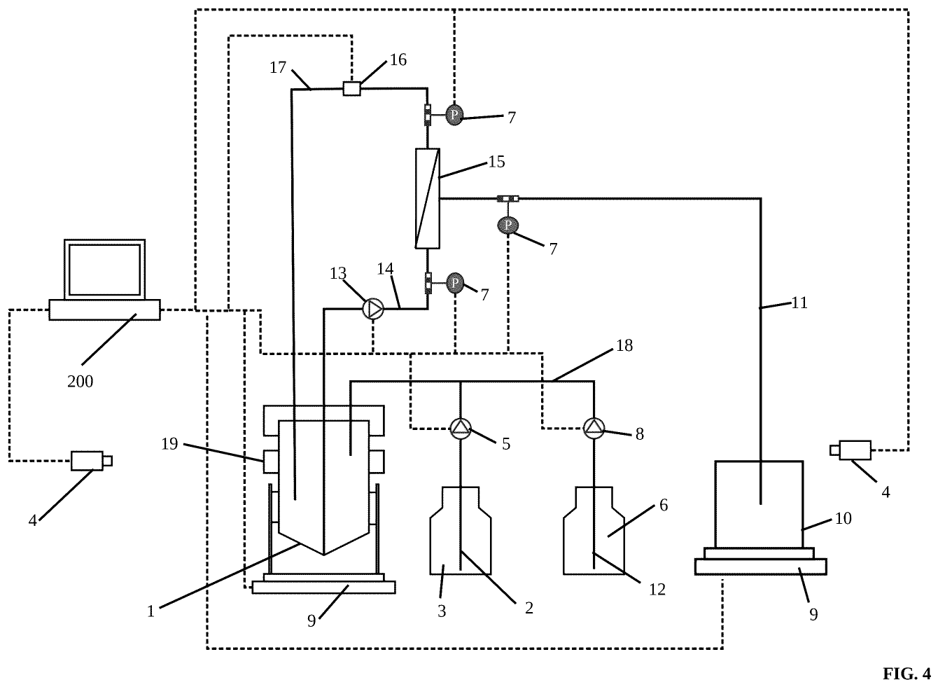

Reference is now made to FIG. 3, where it is exhibited exterior container markings that enable precise, non-contact fluid volume estimation using the integrated machine vision technique. These graduated indicators calibrated to actual container geometries are applied to process reservoirs like feed tanks and permeate collection vessels.

The high liquid stop level mark (30) corresponds to volumes approaching the safe operational limit, triggering automated corrective interventions like pump suspension to prevent overflow. The upper high alarm material level indicator (31) signals volumes within acceptable bounds but nearing limits. These graduated alarms allow proactive resilience against variability in process parameters.

The normal operational range (32) demarcates working volumes during regular functioning like during recirculation or concentration. As volumes deplete during product collection, the lower indicator lines help anticipate end-of-process, allowing operators to prepare for the next step. The low material alarm (33) signals minimal residual volume left. The lowermost mark (34) indicates liquid level reached stop or close to empty.

While it is preferred that containers with volume markers in the pre-trained containers are utilized, but the system can be made capable of determine liquid level and volume of ungraduated bottle with enough training, wherein the aforementioned liquid level can still enable automated control.

In some embodiment, one imaging capture device can be used to monitoring the liquid level of multiple containers. In some other embodiment, multiple imaging capture systems can be used to monitor same or different containers to provide more robust information or 3D images.

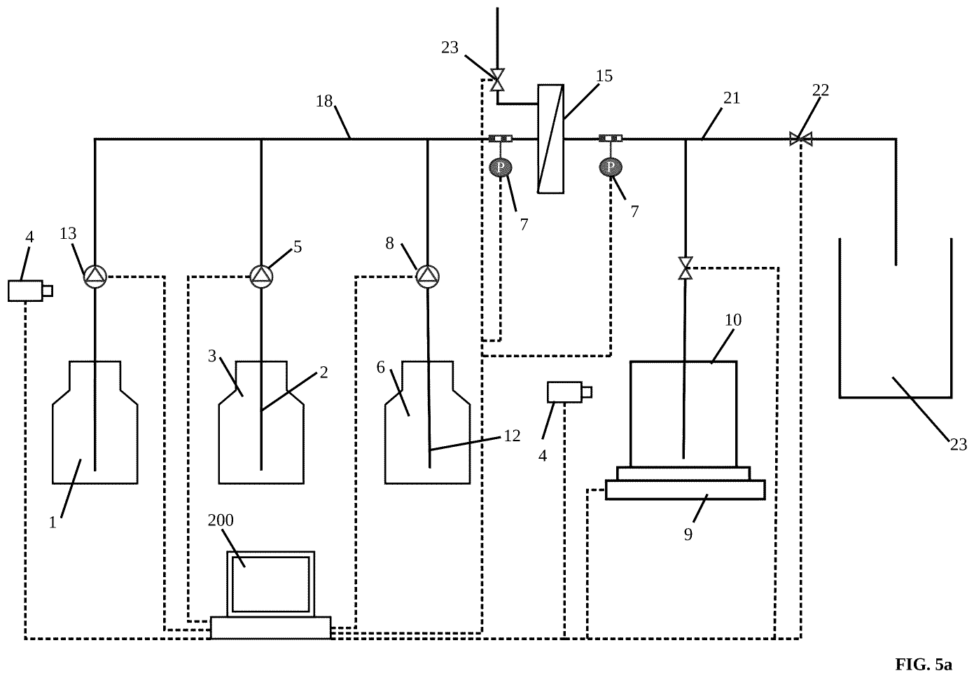

Now referring to FIG. 4, it is illustrated an automated tangential flow filtration assembly with integrated machine vision for closed-loop monitoring and control. The automated filtration system suitable for tangential flow filtration operations includes at least one circulation pump (13), at least one machine vision capturing system for detecting the liquid level in containers, including image capture devices (4) and computer (200) equipped with imaging processing software, the replenishing pipeline (18), a control system for controlling the circulation pump (13) and a tangential flow filtration system flow path. The tangential flow filtration (TFF) flow path includes a sample container (1), additional container (3), container (6) for buffer or additional samples, a TFF device (15), feed pipeline (14), return pipeline/tubing (17), filtrate/permeate pipeline (11), and filtrate container (10). System components and machine vision liquid level detection systems are connected to the control computer system, which includes a controller that can control the opening of the system components, such as back-pressure valve (16), pumps, and record readings from imaging capturing device, scale readings among other data points.

Furthermore, the replenishing pipeline (18) includes a sample/liquid replenishing pipeline (2) and/or a buffer/sample replenishing pipeline (12), with the first replenishing pump (5) set on the replenishing pipeline (2); the second replenishing pump (8) set on another replenishing pipeline (12), with the liquid container (3) for additional sample or buffer connected to the sample container (1) through the liquid replenishing pipeline (2), and another container (6) connected to the sample container (1) through the replenishing pipeline (12).

Practically, the inlets of the feed liquid replenishing pipeline (2) and the buffer replenishing pipeline (12) should be close to the bottom of the container to facilitate the complete uptake of feed liquid or buffer, with the circulation pump (13) arranged on the feed pipeline (14). Optionally, the inlet of the replenishing pipeline (18) is in contact with the inner wall of the sample container (1) or the outer wall of the return pipeline (17). By placing the replenishing pipeline (18) against the wall, bubble generation can be avoided. The additional sample or buffer liquid is placed into the container (3) or (6). Alternatively, the liquid in containers (3) or (6) can have separate tubing to connect with feed tubing (14) before the pump (13).

Furthermore, the sample container (1) is connected to the filter (15) through the feed tube (14), with the filter (15) also connected to the filtrate/permeate tubing (11) and the return tubing (17). The other end of the return tubing (17) is connected to the sample container (1), and the filtrate tubing (11) is connected to the filtrate/permeate container (10) or waste disposal.

Moreover, an external machine vision image capture device (4) can monitor containers (1), (3), and (6), with the image capture device (4) data-connected to the controller computer system (200), capable of detecting the amount of liquid in the sample container (1) or containers (3) and (6), or (10). Further, another external machine vision image capture device (4) can monitor container (10) if it is positioned in a way preventing it from effective monitoring by the first machine vision image capture device, with data connected to the controller computer systems.

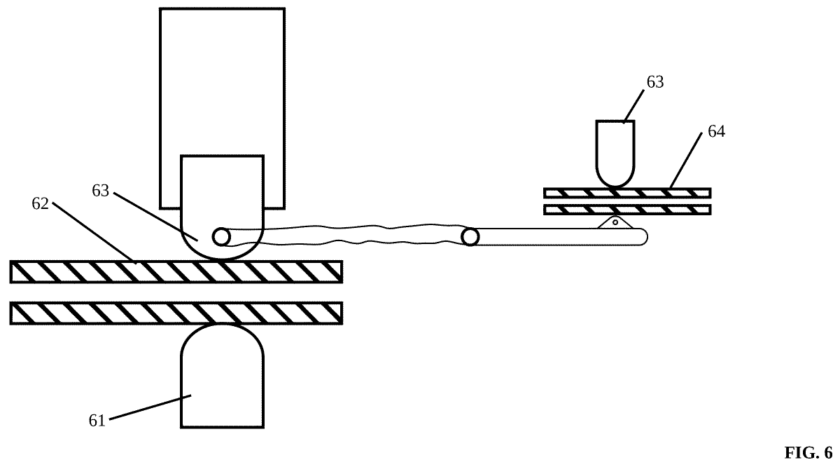

Further, an optional back-pressure control device (16) is set up on the return pipeline (17), with the back-pressure control (16), which can adjust the pressure on the return pipeline (17) to maintain and control tangential flow trans-membrane pressure (TMP) in desired range. In some embodiments, the back-pressure valve is an indirect back-pressure control valve controlled by a lever linkage (as shown in FIG. 6) to improve the precision of pressure control if a fine tubing is used.

Further, the filtrate container (10) is also equipped with a weighing scale (9) if more accurate permeate flow rate data is desired or the container is not transparent, which is used to detect the weight of filtrate container (10). During the process of tangential flow filtration, the weighing scale (9) monitors the quality of the filtrate over time, which can be used to calculate and analyze the flux of tangential flow filtration in real-time.

In a non-limited aspect, during the tangential flow filtration operation, the circulation pump (13) is controlled by the controller to deliver the feed liquid inside the feed liquid container (1) into the filter (15) through the feed pipeline (14). The trans-membrane pressure generated by the circulation pump (13) drives the filtration processes, and a part of the feed liquid and relatively small-sized particles pass through the filter medium in the filter device (15) to form filtrate, which is collected into the filtrate container (10) through the filtrate pipeline (11). The feed liquid that does not pass through the filter medium in the filter (15) returns to the feed container (1) through the return pipeline (17), thus forming a circulation route.

Further, the controller can control the opening and closing of the first replenishing pump (5) and/or the second replenishing pump (8), and additional feed/sample liquid or buffer is drawn into the feed liquid container 1 through the replenishing pipeline (18), maintaining a consistent flow rate of feed liquid or buffer with the filtration flux to keep the volume in the feed liquid container (1) constant. Machine vision recognition can observe the liquid level in the sample container, controlling the status of the pump and reporting status.

In an exemplary continuous feed concentration and then buffer exchange process, a part of sample is loaded in container (1) and additional sample is loaded in container (3). During the concentration process, the controller controls the first replenishing pump (5) to open and the second replenishing pump (8) to close. The machine vision system monitors the liquid level in container (1) and provides the liquid level information to the control computer (200). The control computer controls the flow rate of pump (5) to replenish sample into container (1) at the same rate as the permeate flow entering container (10), to maintain a constant volume in container (1). When the feed liquid in feed liquid container (3) is exhausted, the liquid level in container (1) cannot be maintained constant, and the machine liquid level recognition system can send a signal to the computer (200). The control computer can send/record messages. At the same time, the control system can stop first replenishing pump (5) and turn on the second replenishing pump (8), switching from the concentration mode to the constant volume liquid exchange mode. The control system including machine vision liquid detection can maintain the constant volume in container (1) during the buffer exchange step until the desired number of buffer exchanges is completed or the buffer in container 6 cannot be withdrawn.

In some aspects, if the feed liquid that needs to be concentrated is also replaced with another buffer, a sequential liquid exchange operation of two kinds of buffer can be performed. One variation of such an example is to define a concentration factor or final volume during the concentration step. After the volume of sample in container (1) is reduced to desired level, the system can start buffer exchange by control the pump (5) to replenish buffer into the container (1). After the sufficient amount of buffer exchange is achieved or buffer in container (3) depleted, the system can stop pump (5) and open pump (8) to initiate the second buffer exchange steps. It is also optional to further concentrate the sample after completion of buffer exchange. In a non-limiting illustration, during the process, the automatic pressure control valve (16) can be engaged to maintain a constant feed pressure or trans-membrane pressure, which can be determined through the pressure transducer (7).

Additionally, safety features may be integrated to handle procedural exceptions. For example, the system can suspend normal concentration or diafiltration cycles if one the following scenarios manifests.

The machine vision suite detects the liquid column in the feed reservoir (1) dropping below a preset allowable level, likely from a tube rupture. This triggers an emergency shutdown by suspending the circulation pump (13) to prevent equipment damage while simultaneously sounding audio visual alarms to alert operators.

Likewise, alarms activate should inlet pumps (5, 8) operate at maximum flow rates without being able to maintain stable retentate volumes, indicating insufficient buffer or feed stock. The system records volume trends across all containers over the entire process timeline facilitates tracing the root cause during troubleshooting.

Optionally, the assembly also automatically terminates regular functioning on attaining target concentration factors or completing a set number of sequential buffer exchange stages. Thereby the system offers comprehensive protection against anomalies and process deviations well beyond human operators, promising significantly enhanced reliability.

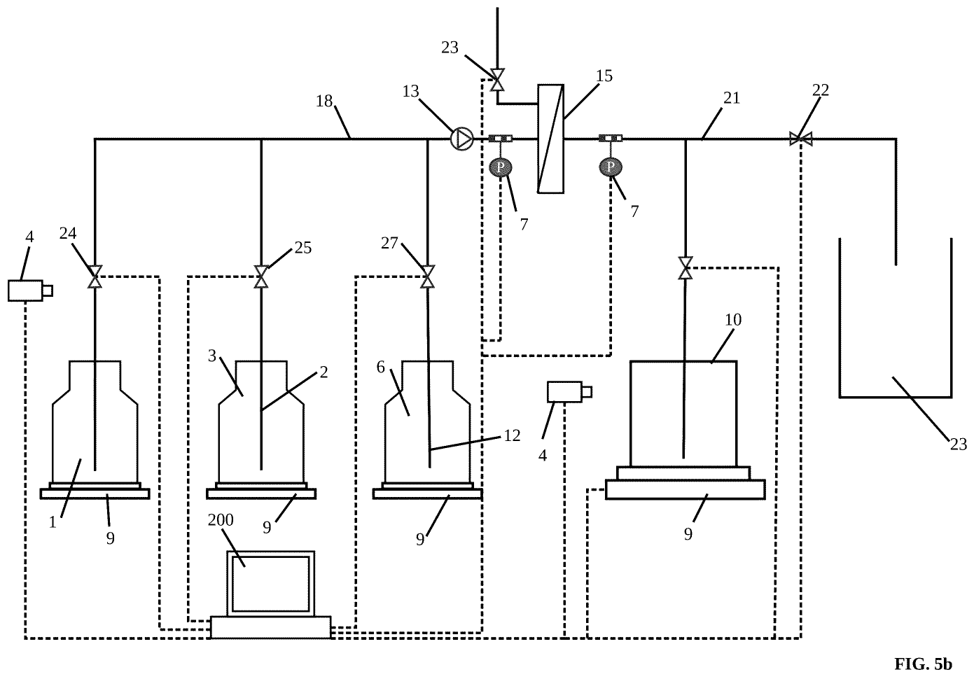

Now referring to FIG. 5A and FIG. 5B, is an embodiment wherein it is depicted an alternate deployment of the invention for automated oversight and regulation of a direct flow, single-pass filtration process. This embodiment serves as an illustrative example of the application of an automated filtration system in direct-flow filtration operations. Notably different from the preceding embodiments, the replenishment pipeline for sample or buffer (18) is directly linked to the direct-flow filter (15) in this setup, bypassing the sample container (1) and feed pipeline (14) outlined in the embodiment of FIG. 4. Moreover, in this iteration, the pump (13), referred to as the feed liquid pump, is positioned on the replenishment pipeline (18), rendering the return pipeline (17), present in the embodiment of FIG. 4, optional but unnecessary for direct flow filtration. The automated filtration system in this embodiment efficiently directs feed liquid from the feed liquid containers (3) or (6) through the filter (15) into the filtrate container (10) without the need for recirculation.

This embodiment of the automated filtration system comprises at least one filtration pump (13), a machine vision imaging system for detecting liquid levels in containers (1), (3), (6), and (10), a control system determining liquid levels from images captured by the imaging capture device (4), and governing the filtration pump (13) and other pumps, along with a direct-flow filtration flow path. The latter includes the filter (15), connection tubing, and liquid containers (3) or (6), with the machine vision system data-connected to a control system, which houses a controller.

In some aspects, the replenishment pipeline (18) encompasses a feed liquid replenishment pipeline (2), facilitating the flow of additional feed or buffer liquid from the feed liquid container (1) to the filter (15). The pump (13) is positioned on the replenishment pipeline (18).

Additionally, the automated filtration system may incorporate extra containers (3, 6) connected to the filter (15) through buffer replenishing pipelines (2 or 12). A replenishing pump (5 or 8) is deployed on the respective pipeline (2 or 12). In some aspects, the pressure transducers 7 can optionally be applied before or after the membrane filter (15), and valves (21 and 22) can be utilized to control fluid flow through the filter.

In the automated direct-flow filtration operation, several sequential steps may be involved. Firstly, in the initial filter flushing phase, once the flow path is established, the pump (5) may transport rinsing buffer from container (3) to the filter. The buffer, traversing the filter, is then directed into the waste container (23) through an opened valve (22), while valve (21) remains securely closed.

Moving on to the filtration stage, when the washing buffer in container (3) becomes empty, or sufficient washing volume achieved, as monitored by the machine vision liquid detection system, pump (5) is deactivated. Then, pump (13) is engaged to convey the sample to the membrane filter (15). The filtered sample is systematically collected in container (10) through an opened valve (21), with valve (22) in the closed position.

Following after the filtration stage, the subsequent rinsing step mirrors the filtration process. Upon depletion of the sample or when container (1) is found to be empty, as detected by the machine vision system, the pump (13) may be disengaged. In this phase, pump (8) is activated to deliver rinsing buffer to the membrane filter (15). The resultant collected sample may be partially directed into container (10) via an opened valve (21), while valve (22) remains closed if desired. Additionally, excess rinsing buffer can be directed to container (23) or onwards for disposal.

It is preferred that the machine vision system may determine liquid levels in containers (1, 3, 6, 10, and 23), and also monitor air bubbles within the flow path, triggering alarms if needed. This feature is particularly valuable in the absence of pressure transducers, as the presence of air bubbles may impede effective liquid flow through the filter (15), leading to elevated back-pressure. The machine vision detection systems can offer additional features if further trained. Additionally, a bubble trapping device or a section buffer diverting tubing with venting might be implemented to all the bubble to bypass the filter.

Optionally, it may be preferred to use only one filtration pump (13) as illustrated in FIG. 5B to withdraw liquid from one or more containers and convey it to the filter (15) via the feed line (18). In this embodiment, the valves (24, 25 and 26), preferably comprising automated solenoidal valves or the like for computerized control, are positioned on the various feed lines (18, 2, 12) to select the liquid source to be pumped.

Specifically, valve (24) is situated on main feed line (18), valve (25) is on secondary feed line (2) potentially connected to reservoir (3), while valve (26) lies on tertiary feed line (12) potentially serving reservoir (6). By selectively opening or closing these valves in appropriate sequences, a single pump (13) can intelligently draw the needed liquid from container (1, 3 or 6 filtrating it through the membrane filter (15).

Further, optional weighing scales (9) can be positioned beneath one or more of containers (3, 6, and 10). The scale under container (10) directly monitors filtration flux, uploading measured weight values to the control system, enabling pump rate adjustments, or issuing alarms when necessary.

Further, in an illustrative and non-limiting embodiment, optional weighing scales (9) beneath containers (3, 6, 10) give accurate real-time estimates of liquid volumes by continuously measuring weights, particularly in machine vision training steps. As an example, the scale under collection vessel (10) provides data to determine filtration flux, with this critical process data transmitted to the control system. Thereby flux rates outside acceptable bounds can rapidly modulate the shared pump (13) speed to avoid filter fouling or damage. The scales also diagnose anomalies based on measured and predicted weight thresholds, automatically issuing alerts. This exemplary embodiment has demonstrated that integrating a single pump with automated valves and weigh scale metrology coupled by a detection-response control system enables both cost savings and superior process regulation. Liquid multiplexing alleviates redundant pumping hardware while closed-loop feedback afforded by the scales boosts filtration reliability, efficiency and safety and facilitate neural network software training.

The exemplary illustration of FIG. 6 exhibits a moving mechanical actuator forming part of the integrated automation pinch valve enabling enhanced and more accurate adjust and control of backpressure for a wide range of tubing size. The illustrated valve allows two different slots to position different sizes of tubing. It comprises a fixed stationary piece (61) against which a larger diameter flexible tubing (62) attaches, and also another fixed stationary piece (63) against which a smaller diameter of tubing is used.

The centerpiece is a movable actuator arm (63) that rotates about a pivot. As the arm rotate and moving piece presses against the diameter of the tubing, it smoothly occludes the tubing lumen flow channel. Thereby flow rate through the tubing can be more precisely regulated by controlling the arm's angular position, fully closing or opening the lumen. This design allows using one actuator to drive the moving pieces of (63) and (62) of two tubing installation slots, each intended for different sizes of tubing's, thus allow great flexibility. By adjusting the pivot point position and relative distance between the valve and the pivot point, one can allow a big actuator to exert a fine and precise control of back pressure for a small tubing to avoid pressure overshoot. It can also allow small actuator to exert a strong force needed to control a larger or stronger tubing.

This elegant yet robust mechanical design allows tight control of fluid movement using straightforward instrumentation like small servo motors without requiring multiple valve systems. The actuator can facilely embed within limited spaces of compact filtration system and filtration flow path. Coupled to the machine vision input, the actuators facilitate closed-loop flow control and back-pressure regulation through real-time feedback.

As such, employing an optimized pinching location allowing sensitive responses and fabricating the actuator tip from smooth and partial elastic materials that limit tubing damage and dampen the pressure overshoot, the system enables extremely fine flow/or pressure adjustments. Overall, the innovation furnishes a compact, adaptable, and cost-effective flow control element to enhance filtration automation.

In certain embodiments involving the application of systems for direct-flow filtrations, the maintenance of constant back pressure is achieved by adjusting the pump rate of the filtration pump, a function controlled by the automated control system. This control system, relying on pressure sensors, continuously monitors back pressure levels. If the back pressure deviates from the established target, the pump rate is dynamically adjusted: increased when the back pressure is below the target and decreased when it surpasses the target.

An alternative method for achieving constant pressure involves the integration of an additional pressured container, wherein an air-tight pressure container is utilized for the samples, with a portion of the sample ported into the container, leaving a substantial top clearance for effective air buffering. The pressure container is equipped with a sample withdraw port at the bottom, and a feed tubing section connects this withdrawal port to the filter inlet. A pressure sensor is applied to the feed tubing or the pressurized tank to monitor back pressure, while the liquid level in the container is determined by machine vision systems or a scale.

Further, the liquid volume in the pressure container is replenished by a pump, delivering additional sample or buffer. Further, a positive displacement pump, such as a peristaltic pump, is employed to add more air to the container if excess air is carried away. Conversely, if an excess of air is present, it can be released through the vent valve or by reversing the pump. The advantage of this embodiment includes dampened pulsation from using a peristaltic pump, and potential tubing damages for wear and tear of tubing. This embodiment eliminates the need for external source of compressed air to drive the filtration at constant pressure filtration, rendering the filtration more portable.

The described automated tangential flow filtration system with integrated machine vision could be implemented either fully locally on an integrated hardware apparatus, or in a distributed architecture utilizing a client-server model.

In a standalone approach, the imaging devices, vision processing units, encryption, authentication protocols, control systems and feedback links could potentially be realized on a single hardware filtration apparatus without reliance on external communication.

Alternatively, a centralized implementation could distribute tasks between filtration scanner devices and a remote verification server. Local scanner units may capture images, display interfaces, adjust pumps/valves and transmit multivariate data to the server. The server could then perform decryption, database comparisons, failure mode diagnostics, and transmit back processed results directing corrective actions at individual scanners.

The optimal realization depends on factors like computing needs, cybersecurity priorities, communication bandwidth, and real-time responsiveness. User-facing, safety-critical filtration operations are best device-controlled, while extensive analytics leverage the server. But the invention could be partitioned across hardware-software.

Embodiments may take the form of integrated or standalone filtration hardware, a distributed scanner-server architecture, or a computer program product storing instructions for variable levels of coordination. Program embodiments may comprise computer readable media encoded to direct linked processors to enact various specified functions.

The described data processing pipelines could be encoded as executable logic, analog electrical circuits, firmware, or combinations thereof to yield an apparatus with the stated capabilities. The instruction set may load onto multipurpose or specialized processors to generate means for achieving the innovations.

Reasonable modifications and combinations of the described embodiments fall within the scope of the claimed invention. Thus, the applicant intends to cover all related alterations and substitutes aligned with the inventive concepts.

### INDUSTRIAL APPLICATION

The present invention has industrial applicability in biotherapeutic processing, gene therapy, vaccine development, protein purification and labeling, cell harvesting, nucleic acid isolation, and R&D of other bioproduction application, among others. The integrated machine vision allows continuous volume tracking and more advanced process monitoring to automated buffer mixing, media exchanges, concentration, filtration, and quality monitoring for fail-safe unattended sample preparation. Additional applications encompass filtration of organoid cultures, circulating biomarkers, extracellular vesicles, drug discovery, virus particles, microorganisms, nanomaterials, environmental assays and toxicity studies, sample pretreatment or handling, among others. Usage in quality control modules of high-throughput automation setups is foreseeable.

What is claimed is:

1. An automated tangential flow filtration system comprising:
a tangential flow filtration unit comprising at least a recirculation pump, a TFF filter, a process container, a feed tubing conveying sample from the process container to the inlet of the TFF filter by the recirculation pump, a retentate tubing conveying sample from the outlet of the TFF filter back to the process container or a retentate holder if in single pass TFF mode, and a permeate tubing collecting filtrate;
an imaging capturing module comprising one or more cameras configured to capture images of the filtration unit;
an image processing unit configured to execute one or more neural network models trained to analyze said images and determine key parameters including one or more of fluid levels, component positions, concentrations, color, turbidity, or leaks;
a control unit configured to predictively actuate one or more pumps, valves, or other components operatively coupled to the filtration unit based on current process state and prescribed targets; and
a closed-loop feedback architecture continuously strengthening and improving the one or more neural network models based on captured image data and control unit actuation over time.

2. The automated tangential flow filtration system of claim 1, wherein the filtration cycle terminates upon at least one of: sample or buffer depletion, high or low pressure thresholds, target final retentate volume, or completion of a set number of diafiltration stages.

3. The automated tangential flow filtration system of claim 1, wherein the image processing unit determines fluid levels or volume by detecting liquid/air interface against visible graduation marks or volume labels on one or more process containers.

4. The automated tangential flow filtration system of claim 1, further comprising one or more replenishment pumps configured to refill one or more process containers based on fluid levels determined by the image processing unit.

5. The automated tangential flow filtration system of claim 1, wherein the control unit actuates one or more back pressure control valves, wherein said valves preferably comprise multiple slots to install tubing and one actuator to control these slots through a rigid lever.

6. The automated tangential flow filtration system of claim 1, further comprising one or more pressure transducers monitoring filtration pressure, providing data to the control unit.

7. The automated tangential flow filtration system of claim 1, wherein the image processing unit detects process anomalies including leaks, tube ruptures, blockages, or color changes, triggering automated safety intervention by the control unit.

8. The automated tangential flow filtration system of claim 1, wherein the closed-loop feedback architecture enables continuous enhancement of the one or more neural network models to handle photometric variance, occlusion, and background clutter in industrial environments over time.

9. An automated direct flow filtration system comprising:
a direct flow filtration unit comprising at least a filter, a pressurized tank or a filtration pump that exert pressure for fluid to pass the filter, a feed container, a section of tubing conveying sample, buffer, to the inlet of the filter driven by the filtration pump or the pressured tank;
an imaging module comprising one or more cameras configured to capture images of the filtration unit;
an image processing unit configured to execute one or more neural network models trained to analyze said images and determine key parameters including one or more of fluid levels, component positions, concentrations, color, turbidity, pH value, or leaks;
a control unit configured to predictively actuate one or more pumps, valves, or other components operatively coupled to the filtration unit based on current process state and prescribed targets; and
a closed-loop feedback architecture continuously improving the one or more neural network models based on captured image data and control unit actuation over time.

10. A method for automated operation of a filtration system of claim 9, the method comprising the steps of:
assembling a filtration flow path including connecting container using tubing to pumps or the pressurized tank, valves and a filter;
loading sample and buffer solutions into the feed container;
executing an optional flushing cycle by pumping flushing buffer through the filter to waste;
initiating a filtration cycle by pumping sample through the filter and collecting filtrate;
monitoring and controlling the filtration cycle through at least one of a constant backpressure mode, constant flow rate mode, manual or flexible mode, target final volume or target concentration factor; and
terminating filtration and executing an optional rinsing cycle by driving rinsing buffer by the pump or the pressurized tank through the filter and optionally collecting initial rinse filtrate before diverting remaining filtrate to waste.

11. The method of claim 10, wherein back pressure regulation is achieved by:
using an airtight pressure container with clearance for air buffering, a sample load port, sample exit port, and pressure measuring device connected to the container or on downstream tubing;
detecting back pressure from the pressure tank; and
adjusting pump output rate higher or lower if detected pressure deviates below or above a pressure set point target.

12. The method of claim 11, further comprising activating a replenishment pump introducing additional sample or buffer into the pressure container to feed the filtration process and maintain sample volume in the desired range.

13. The method of claim 11, further comprising activating a pump to adjust air volume or pressure inside the container if amount of air is deviated for the defined range.

14. The method of claim 10, further comprising steps of:
continuously capturing images of interconnected process containers and circuitry using machine vision;
inferring fluid volumes, turbidity, colors, and process integrity from images using trained neural network models; and
directing pump and valve actuation based on analyzed images enabling closed-loop control of process parameters.

15. The method of claim 14 further comprising detecting anomalies based on analyzed images.

16. The method of claim 10, wherein the flushing, filtration and rinsing cycles are controlled based on container fluid volumes inferred from analyzed images captured by a machine vision system.

17. The method of claim 10, wherein the filtration cycle terminates upon at least one of:
sample depletion, low flux threshold, high pressure threshold, target final retentate volume, tarter permeate volume, or completion of a set number of diafiltration stages.

18. A computer program product for automated filtration, the computer program product comprising a non-transitory computer readable medium storing instructions that when executed by a processor causes the processor to:
receive images of a filtration system captured by one or more imaging capturing devices;
process the images using one or more neural network models to determine fluid levels, component positions, process anomalies or other parameters;
predictively send control signals to pumps, valves or other actuators on the filtration system based on prescribed control targets and the determined parameters; and
continuously retrain the one or more neural network models by incorporating additional captured image data associated with prior control signals to adaptively enhance automation performance.

19. The computer program product of claim 1, wherein the one or more neural network models localize and classify liquid level against graduation markers, labels, tube connections, leaks, blockages or other salient features necessary for automated regulation of the filtration system.

20. The computer program product of claim 1, wherein predictive control logic actuates resource replenishment, pressure regulation, flow direction or safety interventions based on detected process state from analyzed images.

21. The computer program product of claim 1, wherein diagnostic inferencing identifies root causes for process deviations by comparing temporally correlated control signals and multimedia analytics associated with incidents.
